(19) United States
(12) Patent Application Publication
(10) Pub. No.: US 2022/0371254 A1
(43) Pub. Date: Nov. 24, 2022

(54) ROTARY EXTRUDER

(71) Applicant: ZUIKO CORPORATION, Osaka (JP)

(72) Inventors: Masaya OOUE, Osaka (JP); Takayoshi KAWANO, Osaka (JP)

(21) Appl. No.: 17/765,876

(22) PCT Filed: Sep. 25, 2020
(86) PCT No.: PCT/JP2020/036205

§ 371 Date: Apr. 1, 2022

(30) Foreign Application Priority Data
Oct. 16, 2019 (JP) 2019-189192

(51) Int. Cl. B29C 48/40; B29C 48/37; B29C 48/465; B29C 48/87

(52) U.S. Cl. CPC B29C 48/40; B29C 48/37; B29C 48/465; B29C 48/87

(57) ABSTRACT

The present rotary extruder includes: a rotor having a cylindrical surface centered on a rotor axis extending in a horizontal direction; and a casing having an inner peripheral surface that defines a bore, wherein: the casing defines an input port into which a resin material including a thermoplastic resin is fed, and a discharge port from which a plasticized molten resin is discharged; the cylindrical surface of the rotor and the inner peripheral surface of the casing are arranged eccentric with each other, thereby forming a gap whose cross section is crescent-shaped, extending in a rotation direction of the rotor from the input port to the discharge port between the inner peripheral surface and the cylindrical surface; and the input port is arranged at a top portion of the casing and the discharge port is arranged at a lower portion of the casing.

### TECHNICAL FIELD

The present invention relates to a rotary extruder for melting and discharging a thermoplastic resin.

### BACKGROUND ART

Conventional methods, in which a thermoplastic resin is melted to be used as a hot melt adhesive or for manufacturing films, strands, etc., have been known in the art.

Examples of an apparatus for melting and discharging a thermoplastic resin include rotary extruders described in the first patent document and the second patent document identified below, for example.

### CITATION LIST

### Patent Document

[FIRST PATENT DOCUMENT] U.S. Pat. No. 4,887,907 B
[SECOND PATENT DOCUMENT] U.S. Pat. No. 4,813,863 B

FIG. 5 shows an example of a system for feeding and melting a resin material Be including a thermoplastic resin in a rotary extruder disclosed in the second patent document.

In this rotary extruder, the inner circumferential surface of a casing 2 and a cylindrical rotor 1 are arranged eccentric with each other, and the resin material Bs is plasticized in an arc-shaped gap (the kneading section 3) therebetween so as to discharge a molten resin B from a discharge port P2 arranged beside the gap (the kneading section 3).

### SUMMARY OF INVENTION

With such a structure, the molten resin B needs to be pushed up from a position that is orthogonally downward of the rotor 1 to a position that is orthogonally sideward of the rotor 1. Now, if the viscosity of the plasticized resin material Be is high, it is possible to stably feed the molten resin to the next process.

However, if the viscosity of the plasticized thermoplastic resin (molten resin) is low, there is slippage between the rotor 1 and the molten resin, it may not be possible to sufficiently discharge the molten resin from the discharge port P2, which is at an orthogonally sideward position, against the gravity. Therefore, the amount of discharge is likely to fluctuate.

Thus, it is an object of the present invention to provide a rotary extruder capable of discharging stably irrespective of the viscosity of the molten resin.

A rotary extruder of the present invention includes:

a rotor 1 having a cylindrical surface 10 centered on a rotor axis 1S extending in a horizontal direction; and

a casing 2 having an inner peripheral surface 20 that defines a cylindrical hole 2B extending in the horizontal direction, wherein:

the casing 2 defines an input port P1 into which a resin material Bs including a thermoplastic resin is fed, and a discharge port P2 from which a molten resin B, obtained by kneading and plasticizing the resin material Be, is discharged;

the cylindrical surface 10 of the rotor 1 and the inner peripheral surface 20 of the casing 2 are arranged eccentric with each other, thereby forming a kneading section 3, which is a gap whose cross section is crescent-shaped, extending in a rotation direction R of the rotor 1 from the input port P1 to the discharge port P2 between the inner peripheral surface 20 of the casing 2 and the cylindrical surface 10 of the rotor 1; and

the input port P1 is arranged at a top portion 23 of the casing 2 and the discharge port P2 is arranged at a lower portion 24 on an opposite side from the top portion 23 of the casing 2.

According to the present invention, the resin material Be, which is input into the casing 2 through the input port P1, is pushed into a crescent-shaped gap (the kneading section 3), is plasticized as it moves downstream in the rotation direction R of the rotor 1, and is discharged continuously from the discharge port P2. Now, since the discharge port P2 is not arranged at a side portion of the rotor 1 but is arranged at the lower portion 24 on the opposite side from the top portion 23, the molten resin will be discharged uniformly from the discharge port P2 at the lower portion 24 even if the viscosity thereof is low.

### BRIEF DESCRIPTION OF THE DRAWINGS

FIG. 1 is a longitudinal cross-sectional view showing an example of a molten resin maker including one embodiment of a rotary extruder according to the present invention.

FIG. 2 is a transverse cross-sectional view thereof.

FIGS. 3(a), 3(b) and 3(c) are layout views showing the molten resin maker installed in a manufacture line for manufacturing a laminate.

FIG. 4 is a transverse cross-sectional view showing one embodiment of the rotary extruder of the present invention.

FIG. 5 is a transverse cross-sectional view showing an example of a conventional rotary extruder.

### DESCRIPTION OF EMBODIMENTS

The present invention will be understood more clearly from the following description of preferred embodiments taken in conjunction with the accompanying drawings. Note however that the embodiments and the drawings are merely illustrative and should not be taken to define the scope of the present invention. The scope of the present invention shall be defined only by the appended claims. In the accompanying drawings, like reference numerals denote like components throughout the plurality of figures.

One embodiment of the rotary extruder of the present invention will now be described with reference to the drawings.

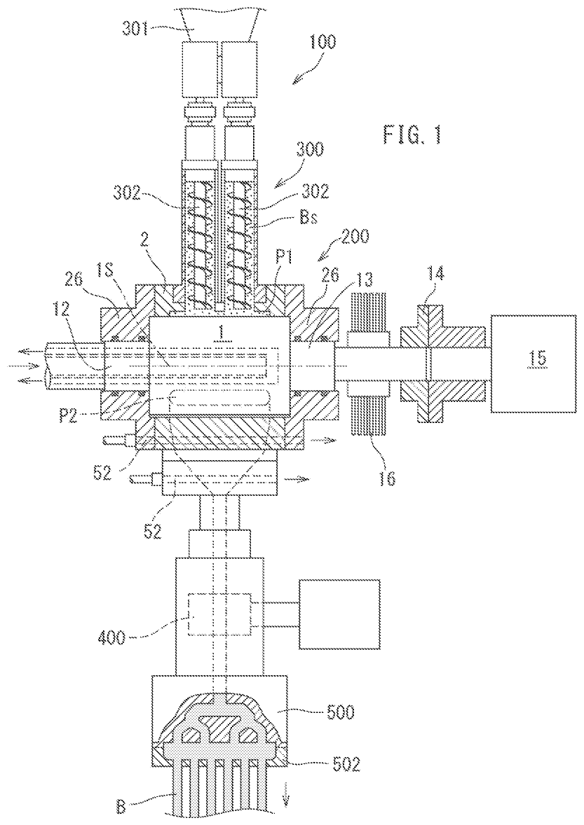

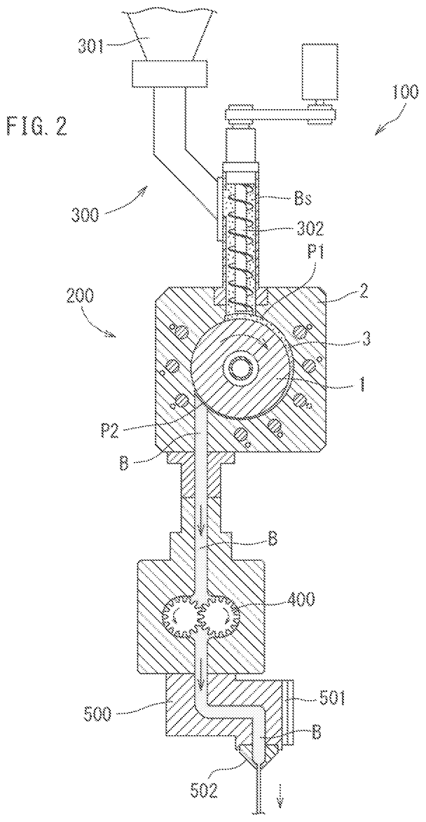

FIG. 1 and FIG. 2 schematically show a molten resin maker 100 including a present rotary extruder 200. As shown in FIG. 1, etc., the molten resin maker 100 is composed of the rotary extruder 200, a material feeder 300, a gear pump 400, a manifold 500, etc.

As shown in these figures, the material feeder 300 is arranged upstream (upward) of the present rotary extruder 200, whereas the gear pump 400 and the manifold 500 are arranged downstream (downward) of the present rotary extruder 200. Before describing the present rotary extruder 200 in detail, these peripheral devices will be described.

The material feeder 300 shown in FIG. 2 includes a hopper 301 and a screw feeder 302 well known in the art. The screw feeder 302 feeds a resin material Be including a thermoplastic resin fed from the hopper 301 to the rotary extruder 200.

Note that together with the resin material Bs, a tackifier and a heat stabilizer, as additives, are also fed to the rotary extruder 200.

The feed rate of the resin material Be may be freely adjusted before being supplied to the screw feeder 302. Specifically, the feed rate may be adjusted by pressure or via a flow control valve.

On the other hand, by increasing the amount of the heat stabilizer, deterioration of the resin material Be can be prevented over a long time even if the heating or the heat retention time is prolonged.

Materials such as polyester, polypropylene, polyamide, butene 1, ethylene vinyl acetate copolymer, butyl methacrylate, styrene butadiene block rubber and styrene isoprene block rubber can be used as the resin material Be. Thermoplastic elastomers may also be used, in which case, for example, polyethylene copolymers may be employed (see JPH10-29259A). These may be used alone or in combination.

Conventional known tackifiers such as rosin and rosin derivatives, phenol resins, terpene resins, coumarone-indene resins, petroleum resins, etc., may be used as tackifiers.

Conventional known antioxidants such as phenol-based, amine-based, sulfur-based, phosphorus-based, benzimidazole-based, etc., can be used as heat stabilizers.

In the present embodiment, two screw feeders 302 are provided, spaced apart from each other in the direction of the rotor axis 1S of FIG. 1. By providing two or more screw feeders 302, the resin material Be can be fed to the input port P1 evenly in the direction of the rotor axis 1S of FIG. 1.

The rotary extruder 200 of FIG. 2 heats and plasticizes the resin material Be that is fed from the material feeder 300. The plasticized molten resin B is passed from the rotary extruder 200 to the manifold 500 through the gear pump 400. Then, as shown in FIG. 1, the molten resin B passes through a die 502 to be discharged in the form of a plurality of narrow and thin tapes, for example.

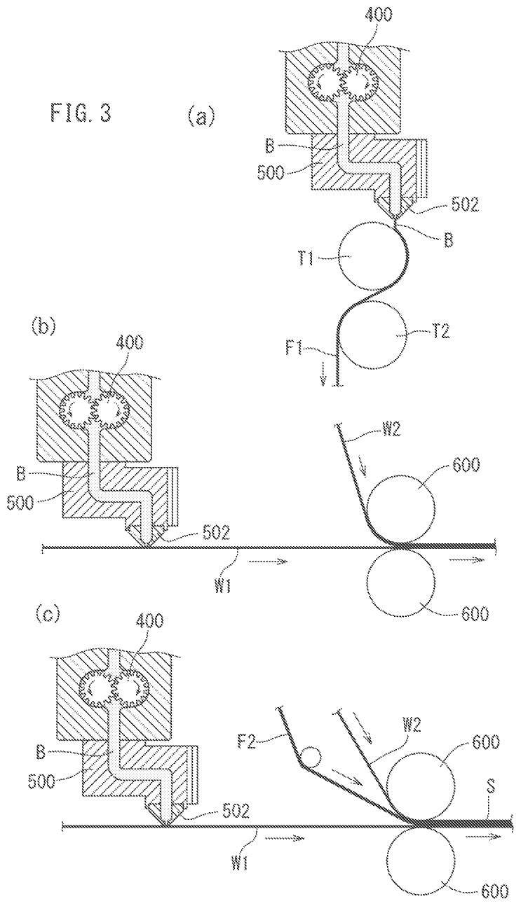

Then, as shown in FIG. 3(a), for example, the molten resin B hanging from the die 502 is cooled on the outer peripheral surface of the first and second cooling rolls T1, T2 to form elastic strands F1. In addition to elastic strands F1, the product may be a resin film or a hot melt adhesive to be described below.

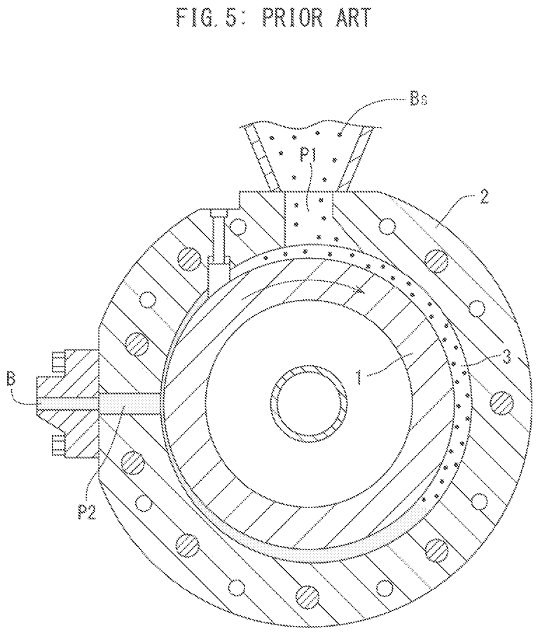

In FIG. 1 to FIG. 5, for the sake of illustration, the resin material Be is shown in a dot pattern and the molten resin B is shown in gray. However, the distinction between the resin material Be and the molten resin B is not necessarily clear, but it is not necessary to clearly distinguish therebetween. Although the boundary between the resin material Be and the molten resin B is shown in some figures, the boundary is merely shown for the sake of illustration and it does not indicate at what point (position) the resin material Be turns into the molten resin B.

Next, the rotary extruder 200 will be described in detail.

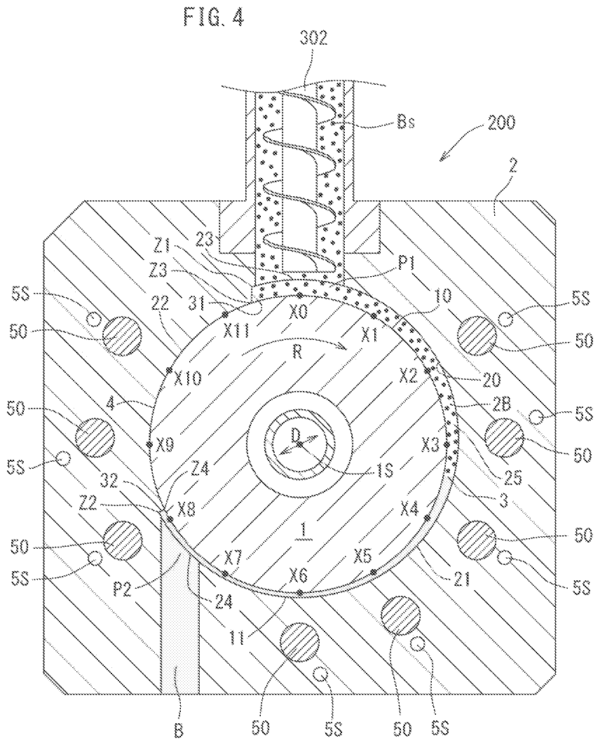

FIG. 4 shows, in a cross-sectional view, the rotary extruder 200. In the figures showing the present embodiment, the rotor 1 is shown to be turning in the clockwise direction for the sake of discussion.

In FIG. 4, the rotary extruder 200 includes the rotor 1, the casing 2, etc.

The rotor 1 shown in FIG. 1 has a cylindrical surface 10 in FIG. 4 centered on the rotor axis 1S extending in the horizontal direction. On the other hand, the casing 2 has an inner peripheral surface 20 defining a cylindrical bore (hole) 2B of FIG. 4 extending in the horizontal direction of FIG. 1. The casing 2 defines an input port P1 into which the resin material Be is fed and a discharge port P2 from which the heated and plasticized molten resin B is discharged.

As shown in FIG. 1, the rotor 1 has integrally formed rotary shafts 12, 13 that protrude from both ends of the rotor 1. These rotary shafts 12, 13 are rotatably supported by end plates 26, 26 which form the casing 2.

A cooling channel may be formed in one (left) rotary shaft 12, through which a refrigerant is introduced to cool the rotor 1. A motor 15 is linked to the other (right) rotary shaft 13 via a joint 14. Note that the other rotary shaft 13 and the joint 14 may be cooled through heat dissipation via fins 16.

As shown in FIG. 1, the input port P1 and the discharge port P2 are formed to be long and parallel to the rotor axis 1S. The tips of a pair of screw feeders 302 are facing the input port P1 elongated in the horizontal direction. The plurality of screw feeders 302 serve to make uniform the feed rate of the resin material Bs.

As shown in FIG. 4, the input port P1 is located at the top portion 23 of the casing 2. On the other hand, the discharge port P2 is located at the lower portion 24 on the opposite side from the top portion 23 of the casing 2. In the present embodiment, the discharge port P2 extends in the orthogonally downward direction.

The gap (the kneading section 3) extends in the rotation direction R of the rotor 1 from the input port P1 to the discharge port P2, and is formed so that the cross section thereof is generally crescent-shaped.

Specifically, the cylindrical surface 10 of the rotor 1 and the inner peripheral surface 20 of the casing 2 are eccentrically arranged with respect to each other. Thus, a gap (the kneading section 3) is formed, extending from the input port P1 to the discharge port P2, between the inner peripheral surface 20 of the casing 2 and the cylindrical surface 10 of the rotor 1.

The kneading section 3 of FIG. 4 extends halfway around the rotor 1 from the input port P1 to a lowest portion 11 of the rotor 1. The kneading section 3 further extends from the lowest portion 11 of the rotor 1 to the discharge port P2, which is above the lowest portion 11 and below a position that is orthogonally sideward of the rotor 1.

A non-kneading section 4 is formed between the casing 2 and the rotor 1 of FIG. 4, extending from a position that is downstream of the discharge port P2 in the rotation direction R of the rotor 1 to a position that is upstream of the input port P1 in the rotation direction R.

In the non-kneading section 4, the cylindrical surface 10 of the rotor 1 closely opposes the inner peripheral surface 20 of the casing 2. On the other hand, in the kneading section 3, the inner peripheral surface 20 of the casing 2 distantly opposes the cylindrical surface 10 of the rotor 1.

In the present specification, “to closely oppose” encompasses a state where the width in the radial direction D of the rotor 1 of the non-kneading section 4 is narrower than the width in the radial direction D of the rotor 1 of the kneading section 3 continuous with the discharge port P2, or a state where the cylindrical surface 10 of the rotor 1 and the inner peripheral surface 20 of the casing 2 are substantially in contact with each other in the non-kneading section 4.

FIG. 4 shows the start point Z1 of the kneading section 3 on the inner peripheral surface 20 side of the casing 2, the end point Z2 of the kneading section 3 on the inner peripheral surface 20 side, the start point Z3 of the kneading section 3 on the rotor 1 side, and the end point Z4 of the kneading section 3 on the rotor 1 side. The casing 2 includes a first weir 31, which is a wall (cliff face) indicated by a line that connects together the start point Z1 of the kneading section 3 on the inner peripheral surface 20 side and the start point Z3 of the kneading section 3 on the rotor 1 side, and a second weir 32, which is a wall (cliff face) indicated by a line that connects together the end point Z2 of the kneading section 3 on the inner peripheral surface 20 side and the end point Z4 of the kneading section 3 on the rotor 1 side.

The kneading section 3 extends from the first weir 31 to the second weir 32 in the rotation direction R of the rotor 1. On the other hand, the non-kneading section 4 extends from the second weir 32 to the first weir 31 in the rotation direction R of the rotor 1.

The inner peripheral surface 20 of the casing 2 of FIG. 4 has a first surface 21 and a second surface 22.

The first surface 21 is defined as a surface extending from the first weir 31 to the second weir 32 in the clockwise direction, and the second surface 22 is defined as a surface extending from the second weir 32 to the first weir 31 in the clockwise direction.

The first and second weirs 31, 32 are arranged at the boundaries between the first surface 21 and the second surface 22, extend in the radial direction D of the rotor 1, and are each formed in a stepped shape. In other words, the first and second weirs 31, 32 connect together the first surface 21 and the second surface 22, and are formed by cliff faces that extend in the radial direction D of the rotor 1 and in the direction of the rotor axis 1S (FIG. 1).

Note that the first and second weirs 31, 32 may not be a stepped shape integral with the casing 2, but may be formed by pieces and bolts (valves) separate from the casing 2 (see the assembly 36 of the first patent document, and the restrictor bar 62, the spaced screws 64 of the second patent document).

In FIG. 4, the crescent-shaped gap (the kneading section 3) narrows from the top portion 23 toward a side portion 25 upstream of the lowest portion 11. The crescent-shaped gap (the kneading section 3) further narrows from the side portion 25 toward the lowest portion 11.

Next, the position of each portion will be described in detail by comparing it to the dial of a clock that displays the hours from 1 o'clock to 12 o'clock.

In FIG. 4, the input port P1 of the top portion 23 is provided between 11 o'clock (the position X11) and 1 o'clock (the position X1).

In the present specification, “top portion” refers to an area between 10 o'clock (the position X10) and 2 o'clock (the position X2), and preferably refers to an area between 11 o'clock (the position X11) and 1 o'clock (the position X1). The center of the feeding of the resin material Bs (the axis of the screw feeder 302) is arranged at the top portion 23.

On the other hand, the discharge port P2 at the lower portion 24 is open to the gap (the kneading section 3) between a position that is before 9 o'clock (the position X9) in the clockwise direction and 7 o'clock (the position X7).

In these cases, the first weir 31 may be located between 12 o'clock (the position X0) and 11 o'clock (the position X11) in the clockwise direction (the rotation direction R), and the second weir 32 may be located at a position that is before 9 o'clock (the position X9) in the clockwise direction (the rotation direction R) and up to 8 o'clock (the position X8) or 7 o'clock (the position X7).

The size of the gap (the kneading section 3) of FIG. 4 gradually narrows from 1 o'clock (the position X1) toward 3 o'clock (the position X3), and further gradually narrows from 3 o'clock (the position X3) toward 6 o'clock (the position X6).

In the present embodiment, the discharge port P2 extends in the orthogonally downward direction from the opening of the gap (the kneading section 3), but it may extend diagonally downward.

The molten resin B discharged from the discharge port P2 shown in FIG. 2 passes through the manifold 500 and the die 502 by the rotary drive of the gear pump 400, thus turning into a large number of thin continuous strips (FIG. 1).

As shown in FIG. 3(a), the molten resin B hanging down from the die 502 is cooled at the outer peripheral surface of the first and second cooling rolls T1, T2 and is conveyed along the outer peripheral surface.

The present rotary extruder 200 of FIG. 4 has the function of heating and controlling the temperature of the molten resin B.

As shown in FIG. 4, a large number of rod-shaped heaters 50 are arranged in the casing 2 around the rotor 1. A rod-shaped temperature sensor (not shown) is arranged in the casing 2, together with the heaters 50, to control heating by the heaters 50. Note that an appropriate control may be performed based on the detected temperature of the temperature sensor.

The refrigerant flow paths 5S arranged in the vicinity of the heaters 50 are for a cooling operation performed when the heaters 50 are heated at or above a predetermined temperature.

The joint 14 of FIG. 1, etc., are provided with the fins 16 for heat dissipation, and the refrigerant air from an air passage 52 provided in the casing 2 cools the fins 16 to prevent heat from being transferred to the motor 15 through the joint 14.

The manifold 500 of FIG. 2 may be provided with a square plate-shaped temperature controller 501 that makes uniform the temperature of the entire manifold 500.

While a case where the molten resin B is elastic strands F1 has been described above with reference to FIG. 3(a), the molten resin B may be a hot melt adhesive, for example, instead of elastic strands F1 in the present invention.

For example, as shown in FIG. 3(b), the molten resin B can also be employed when bonding together a pair of webs W1, W2 that have no elastic strands F. The pair of webs W1, W2 are laminated on each other while being sandwiched between a pair of nip rollers 600, 600. The laminated pair of webs is used in diapers and masks, for example.

As shown in FIG. 3(c), the molten resin B may be applied to one web W1 as an adhesive to sandwich and bond elastic strands F2 between the pair of webs W1, W2, for example.

The pair of webs W1, W2 and the elastic strands F are sandwiched between the pair of nip rollers 600, 600 to produce a stretch sheet S (stretch laminate). The stretch sheet S is used as a stretch sheet for the girth portion of the wearable article, for example.

The positions of the input port P1 and discharge port P2 of FIG. 4 can be set as desired. For example, the discharge port P2 may be located at 6 o'clock (the position X6), which is the lowest portion of the rotor 1, or it may be located between 4 o'clock (the position X4) and 8 o'clock (the position X8), which is below 3 o'clock (the position X3) and 9 o'clock (the position X9).

The specific embodiment described above primarily includes an invention having the following elements.

The rotary extruder 200 includes: a rotor 1 having a cylindrical surface 10 centered on a rotor axis 1S extending in a horizontal direction; and a casing 2 having an inner peripheral surface 20 that defines a cylindrical hole 2B extending in the horizontal direction, wherein: the casing 2 defines an input port P1 into which a resin material Bs including a thermoplastic resin is fed, and a discharge port P2 from which a molten resin B, obtained by kneading and plasticizing the resin material Bs, is discharged; the cylindrical surface 10 of the rotor 1 and the inner peripheral surface 20 of the casing 2 are arranged eccentric with each other, thereby forming a kneading section 3, which is a gap whose cross section is crescent-shaped, extending in a rotation direction R of the rotor 1 from the input port P1 to the discharge port P2 between the inner peripheral surface 20 of the casing 2 and the cylindrical surface 10 of the rotor 1; and the input port P1 is arranged at a top portion 23 of the casing 2 and the discharge port P2 is arranged at a lower portion 24 on an opposite side from the top portion 23 of the casing 2.

With the configuration described above, the resin material Bs, which is input into the casing 2 through the input port P1, is pushed into a crescent-shaped gap (the kneading section 3), is plasticized as it moves downstream in the rotation direction R of the rotor 1, and is discharged continuously from the discharge port P2. Now, since the discharge port P2 is not arranged at a side portion of the rotor 1 but is arranged at the lower portion 24 on the opposite side from the top portion 23, there is unlikely slippage between the rotor 1 and the molten resin even if the viscosity of the molten resin B is low. Therefore, the molten resin B can be discharged stably from the discharge port P2 at the lower portion 24 irrespective of the viscosity of the plasticized thermoplastic resin.

In a preferred embodiment, the kneading section 3 extends halfway around the rotor 1 from the input port P1 to a lowest portion 11 of the rotor 1, and further extends from the lowest portion 11 of the rotor 1 to the discharge port P2, which is above the lowest portion 11 and below a position that is orthogonally sideward of the rotor 1.

In this case, the discharge port P2 is arranged at a position farther away from the input port P1 than the lowest portion 11, thus allowing more time to plasticize the thermoplastic resin in the kneading section 3.

In another preferred embodiment, a non-kneading section 4 is formed between the casing 2 and the rotor 1, extending from a position that is downstream of the discharge port P2 in the rotation direction R of the rotor 1 to a position that is upstream of the input port P1 in the rotation direction R, wherein the rotor 1 closely opposes the inner peripheral surface 20 of the casing 2.

In this case, in the non-kneading section 4, the cylindrical surface 10 of the rotor 1 closely opposes the inner peripheral surface 20 of the casing 2, and it is difficult for the molten resin to enter the non-kneading section 4. Therefore, the rotary extruder is unlikely to malfunction due to, for example, carbonization of the resin that has entered the non-kneading section 4.

In another preferred embodiment, in the non-kneading section 4, the cylindrical surface 10 of the rotor 1 closely opposes the inner peripheral surface 20 of the casing 2; and in the kneading section 3, the inner peripheral surface 20 of the casing 2 distantly opposes the cylindrical surface 10 of the rotor 1.

In this case, while the resin material Bs flows downstream while being plasticized in the kneading section 3, the molten resin B is unlikely to enter the non-kneading section 4.

In another preferred embodiment, the casing 2 is provided with a first weir 31 and a second weir 32, which are boundaries between the kneading section 3 and the non-kneading section 4; the kneading section 3 extends from the first weir 31 in the rotation direction R of the rotor 1 to the second weir 32; and the non-kneading section 4 extends from the second weir 32 in the rotation direction R of the rotor 1 to the first weir 31.

Since the kneading section 3 and the non-kneading section 4 are partitioned from each other by the first and second weirs 31, 32 as described above, the resin material Bs can be plasticized in the kneading section 3 while it is possible to prevent the molten resin B from entering the non-kneading section 4.

In another preferred embodiment, the inner peripheral surface 20 of the casing 2 has a first surface 21 and a second surface 22 that are continuous with each other in a circumferential direction; the first surface 21 defines the kneading section 3 and the second surface 22 defines the non-kneading section 4; and a radius of curvature of the first surface 21 is larger than a radius of curvature of the rotor 1, and a radius of curvature of the second surface 22 is smaller than the radius of curvature of the first surface 21.

That is, the inner peripheral surface 20 has the first surface 21 that is spaced apart from the cylindrical surface 10 of the rotor 1 in the kneading section 3 and has a radius of curvature larger than that of the rotor 1, and the second surface 22 that is spaced apart from the cylindrical surface 10 of the rotor 1 in the non-kneading section 4 and has a radius of curvature smaller than that of the first surface 21. The distance between the cylindrical surface 10 and the first surface 21 is larger than the distance between the cylindrical surface 10 and the second surface 22.

In this case, it is easy to form a gap (the kneading section 3) between the cylindrical surface 10 of the rotor 1 and the first surface 21, while it is easy to form the non-kneading section 4 into which the molten resin B cannot easily enter.

In another preferred embodiment, the first weir 31 and the second weir 32 are arranged at boundaries between the first surface 21 and the second surface 22, extend in a radial direction D of the rotor 1, and are each formed in a stepped shape.

In this case, as compared with a case where weirs are formed as movable valves, weirs have higher functionality, and there is unlikely to be a problem such as the molten resin B slipping into between the rotor 1 and the casing 2 to be carbonized.

In another preferred embodiment, the crescent-shaped gap (the kneading section 3) narrows from the top portion 23 toward a side portion 25 upstream of the lowest portion 11. More preferably, the crescent-shaped gap (the kneading section 3) further narrows from the side portion 25 toward the lowest portion 11.

In such cases, the resin material Be is more likely to be kneaded as it moves downstream.

Any feature illustrated and/or depicted in conjunction with one embodiment or preferred embodiments may be used in the same or similar form in one or more of the other embodiments, and/or may be used in combination with, or in place of, any feature of the other embodiments.

While preferred embodiments have been described above with reference to the drawings, obvious variations and modifications will readily occur to those skilled in the art upon reading the present specification.

For example, there may be one screw feeder.

The casing may be in a cylindrical shape instead of a prism shape.

Thus, such variations and modifications shall fall within the scope of the present invention as defined by the appended claims.

### INDUSTRIAL APPLICABILITY

The present invention is applicable to the manufacture of a molten resin obtained by kneading and plasticizing a resin material including a thermoplastic resin.

### REFERENCE SIGNS LIST

1: Rotor, 1S: Rotor axis, 10: Cylindrical surface, 11: Lowest portion, 12, 13: Rotary shaft
14: Joint, 15: Motor, 16: Fin
2: Casing, 2B: Bore (hole), 20: Inner peripheral surface,
21: First surface, 22: Second surface
23: Top portion, 24: Lower portion, 25: Side portion, 26: End plate
3: Kneading section (gap), 31: First weir, 32: Second weir
4: Non-kneading section, 5S: Refrigerant flow path
B: Molten resin, Bs: Resin material including thermoplastic resin
D: Radial direction, F1, F2: Elastic strands, S: Stretch sheet, T1, T2: Cooling roll
W1, W2: Pair of webs
P1: Input port, P2: Discharge port, R: Rotation direction
100: Molten resin maker, 200: Rotary extruder
300: Material feeder, 301: Hopper, 302: Screw feeder
400: Gear pump, 500: Manifold, 501: Temperature controller, 502: Die
600: Nip roller
Z1: Start point of kneading section on inner peripheral surface side, Z2: End point of kneading section on inner peripheral surface side
Z3: Start point of kneading section on rotor side, Z4: End point of kneading section on rotor side

1. A rotary extruder comprising:
a rotor having a cylindrical surface centered on a rotor axis extending in a horizontal direction; and
a casing having an inner peripheral surface that defines a cylindrical hole extending in the horizontal direction, wherein:
the casing defines an input port into which a resin material including a thermoplastic resin is fed, and a discharge port from which a molten resin, obtained by kneading and plasticizing the resin material, is discharged;
the cylindrical surface of the rotor and the inner peripheral surface of the casing are arranged eccentric with each other, thereby forming a kneading section, which is a gap whose cross section is crescent-shaped, extending in a rotation direction of the rotor from the input port to the discharge port between the inner peripheral surface of the casing and the cylindrical surface of the rotor; and
the input port is arranged at a top portion of the casing and the discharge port is arranged at a lower portion on an opposite side from the top portion of the casing.

2. The rotary extruder according to claim 1, wherein the kneading section extends halfway around the rotor from the input port to a lowest portion of the rotor, and further extends from the lowest portion of the rotor to the discharge port, which is above the lowest portion and below a position that is orthogonally sideward of the rotor.

3. The rotary extruder according to claim 2, wherein a non-kneading section is formed between the casing and the rotor, the non-kneading section extending from a position that is downstream of the discharge port in the rotation direction of the rotor to a position that is upstream of the input port in the rotation direction, wherein the rotor closely opposes the inner peripheral surface of the casing.

4. The rotary extruder according to claim 3, wherein:
in the non-kneading section, the cylindrical surface of the rotor closely opposes the inner peripheral surface of the casing; and
in the kneading section, the inner peripheral surface of the casing distantly opposes the cylindrical surface of the rotor.

5. The rotary extruder according to claim 4, wherein:
the casing is provided with a first weir and a second weir, which are boundaries between the kneading section and the non-kneading section;
the kneading section extends from the first weir in the rotation direction of the rotor to the second weir; and
the non-kneading section extends from the second weir in the rotation direction of the rotor to the first weir.

6. The rotary extruder according to claim 5, wherein:
the inner peripheral surface of the casing has a first surface and a second surface that are continuous with each other in a circumferential direction;
the first surface defines the kneading section and the second surface defines the non-kneading section; and
a radius of curvature of the first surface is larger than a radius of curvature of the rotor, and a radius of curvature of the second surface is smaller than the radius of curvature of the first surface.

7. The rotary extruder according to claim 6, wherein the first weir and the second weir are arranged at boundaries between the first surface and the second surface, extend in a radial direction of the rotor, and are each formed in a stepped shape.

8. The rotary extruder according to claim 2, wherein the crescent-shaped gap narrows from the top portion toward a side portion upstream of the lowest portion.

9. The rotary extruder according to claim 8, wherein the crescent-shaped gap further narrows from the side portion toward the lowest portion.
